(19) United States
(12) Patent Application Publication
(10) Pub. No.: US 2012/0235592 A1
(43) Pub. Date: Sep. 20, 2012

(54) Modulated LED

(76) Inventors: Yen-Wei Hsu, Taipei (TW); Whei-Chyou Wu, Fremont, CA (US)

(21) Appl. No.: 13/050,970

(22) Filed: Mar. 18, 2011

(51) Int. Cl. H05B 41/16

(52) U.S. Cl. 315/246

(57) ABSTRACT

The invention relates to a LED, and more particularly, to provide a circuit and a modulator to more efficiently drive a LED resulting in improving the matching between power source and LED, lowering LED junction temperature and emitting brighter, richer and more natural colors in a more capacitive way.

### FIELD OF INVENTION

The invention relates to a LED, and more particularly, to provide a circuit and a modulator to more efficiently drive a LED resulting in improving matching between power source and LED, lowering LED junction temperature and emitting brighter, richer and more natural colors in a more capacitive way.

### BACKGROUND INFORMATION

Solid state devices such as LEDs are subjected to very limited wear and tear if operated at low currents and at low temperatures. The most common symptom of LED (and laser diode) failure is the gradual lowering of light output and loss of efficiency. With the development of high-power LEDs the devices are subjected to higher junction temperatures and higher current densities than that of the traditional devices. Those problems stress on the material and may cause early light-output degradation. Like other lighting devices, LED performance is temperature dependent.

LED is a very high-frequency loading up to x-band or higher so that it is very hard to find a power source to come up with this high frequency, which means that serious unmatching between power source and LED exists. Serious unmatching between power source and LED and unproperly to drive LED causes very low electricity-optic-conversion rate, which means the most electrical power contributes to heat causing high LED junction temperature and only very small portion of the electrical power is converted into light. If the matching between power source and LED is improved, then electricity-optic-conversion rate can be improved leading to lower LED junction temperature, brighter light and less electrical power consumed.

LED is current-driven device, a current is observed when LED emits light, and LED is also a voltage-sensing device, a small change in driving voltage produces large amount of current which could fatally destroy the LED. To properly drive a LED is very important as well. Better matching between power source and LED and more properly driving a LED are revealed in the present invention.

### SUMMARY OF THE INVENTION

It's a first objective to provide a modulated LED which is formed by the coupling of a modulator with a LED.

It's a second objective to provide an open circuit device as the modulator with the LED.

It's a third objective to provide a circuit by employing the modulated LED to improve the matching between power source and LED results in lowering LED junction temperature and emitting brighter, richer and more natural colors in a more capacitive way.

It's a fourth objective to more efficiently drive a LED without needing to change the illuminating structure of the LED.

### BRIEF DESCRIPTION OF THE FIGURES

FIG. 1 has shown an open circuit device;

FIG. 2 has shown a LED driving circuit having an open circuit device;

FIG. 3a has shown an I-V curve of the LED driving circuit shown in FIG. 2 of which the discharge starting voltage of the open circuit device is smaller than the light-emitting starting voltage of the LED 20;

FIG. 3b has shown an I-V curve of the LED driving circuit shown in FIG. 2 of which the discharge starting voltage of the open circuit device is equal to the light-emitting starting voltage of the LED 20;

FIG. 4 has shown a LED driving circuit having two open circuit devices;

FIG. 5 has shown a LED driving circuit having an open circuit device;

FIG. 6 has shown a voltage current characteristic of a typical tunnel diode;

FIG. 7 has shown a LED driving circuit having a tunnel diode;

FIG. 8 has shown a LED driving circuit having two tunnel diodes; and

FIG. 9 has shown an open circuit device having a third terminal disposed between the first terminal and the second terminal of the open circuit device.

### DETAILED DESCRIPTION

An open circuit device, a tunnel diode, a LED and the Budden Tunneling Factor are respectively introduced in advance.

### Open Circuit Device

An open circuit device comprises a first terminal and a second terminal separating the first terminal by an open gap having an open gap width d and an electrical discharge between the first terminal and the second terminal of the open gap can take place and at least one of the first terminal and the second terminal is a discharge electrode of the electrical discharge. The first terminal and the second terminal are not limited in the present invention, for example, they can be conductors or semiconductors.

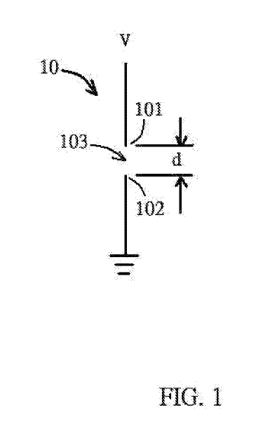

FIG. 1 has shown an open circuit device 10 comprising a first terminal 101 and a second terminal 102 separating the first terminal 101 by an open gap 103 having an open gap width d. The open circuit device 10 is driven by a voltage v. By properly adjusting the voltage v across the open gap 103, the frequency of the voltage v, and the open gap width d, an electrical discharge between the first terminal and the second terminal of the open circuit device 10 can take place and at least one of the first terminal 101 and the second terminal 102 is a discharge electrode of the electrical discharge. The shapes of the first terminal 101 and the second terminal 102 are not limited, for example, the shape can be point or surface. A surface can be viewed as formed by a plurality of points (or called “micro needle array” in the present invention).

A medium disposed in the open gap 103, an ionization condition at the open gap 103, the thermal variation at the open gap 103, the shapes of the two terminals 101, 102 and the materials made of the two terminals 101, 102 can also play important roles in the electrical discharge and add more uncertainties to the electrical discharge. The impedance (including resistance, capacitance and inductance) between the first terminal 101 and the second terminal 102 of the open circuit device 10 chaotically randomly varies between zero and infinity and electrical discharge route between the first terminal 101 and the second terminal 102 may chaotically randomly vary as well.

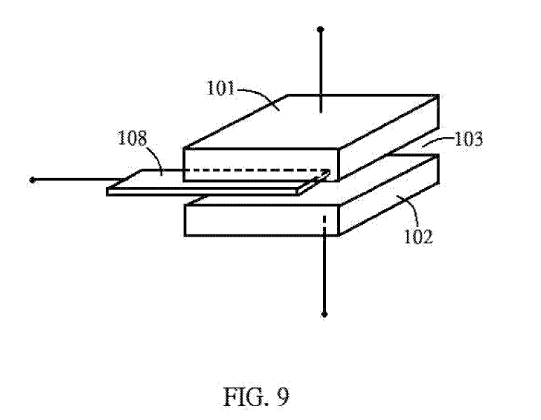

For example, the medium disposed in the open gap 103 can be a gas such as air or inert gas for isolating the two terminals 101, 102 from outside environment against oxidizing. Or, the medium disposed in the open gap 103 can be a third terminal which can be used to receive an input electrical field to change the frequency response of the open circuit device. An open circuit device shown in FIG. 9, a third terminal 108 is disposed between a first terminal 101 and a second terminal 102 of the open circuit device. An electrical field applied to the third terminal 108 will change the charges on both the first terminal 101 and the second terminal 102 resulting in changing the frequency response of the open circuit device. The third terminal 108 can neighbor the first terminal 101 and the second terminal 102 as long as an application of an electrical field on the third terminal 108 can vary the impedance between the first terminal 101 and the second terminal 102 resulting in varying the frequency response of the open circuit device. The impedance variation of the open circuit device implies the variation of the frequency response of the open circuit device.

An ion-release device disposed at the open gap 103 can release or produce ions if excited by an electrical field at the open gap 103, which will also get involved in the conductivity between the first terminal 101 and the second terminal 102 resulting in playing an important role in the electrical discharge. The ion-release device is a device which can release or produce ions if excited by an energy field such as electrical field, thermal field or magnetic field. The ion-release device is not limited in the present invention, for example, it can be a CNT, C₆₀ derivatives or graphene which can produce ions under an excitation of an electrical field.

An initial electrical discharge between the first terminal 101 and the second terminal 102 of the open circuit device 10 starts to take place at a “discharge starting voltage”. An electrical discharge between the first terminal 101 and the second terminal 102 of the open circuit device 10 takes place at a “discharge voltage”.

The behavior of the electrical discharge of the open circuit device 10 is very complicated, which can be proven by its I-V curve. Making the complicated behavior simple, the complicated behavior of the electrical discharge of the open circuit device 10 includes a periodical PDR (Positively Differential Resistance), NDR (Negatively Differential Resistance) and a constant resistance. When a voltage built at the open gap 103 of the open circuit device 10 reaches the discharge starting voltage of the open gap 103, then an initial electrical discharge at the open gap 103 starts to take place causing current to flow through the first terminal 101 and the second terminal 102 and the voltage across the open gap 103 drops to present a NDR. The voltage at the open gap 103 will drop to a level unable to keep the initial electrical discharge, then the electrical discharge stops at the open gap 103 causing no current to flow between the first terminal 101 and the second terminal 102 and a voltage at the open circuit device 10 will be built again to present a PDR until reaching to a next discharge voltage for a next electrical discharge. The PDR and the NDR will periodically proceed with its current between zero and a value. For the purpose of convenience, a periodical PDR and NDR can also be called “tunneling” in the present invention. The term “tunneling” is also a more conventional term known by the people skilled in the art.

The electrical discharge at the open gap 103 of the open circuit device 10 has characterized its chaotically random impedance varying between zero and infinity and its periodical PDR and NDR. Please also notice that a discharge voltage may be different from its previous discharge voltage. Once a voltage across the open gap 103 reaches a discharge starting voltage, an initial electrical discharge starts to take place, and with the voltage going up, the frequency response of the electrical discharge of the open circuit device 10 keeps changing. The electrical discharge at the open gap 103 is not limited, for example, it can be an electrical corona discharge or electrical glowing discharge.

Some experiments have shown this periodical PDR and NDR (or tunneling) can take place at two slightly touching metals at a very low voltage, even lower to 0.2 volt. The open circuit device includes a loose connection such as touching or slight touching connection between its first terminal and second terminal, in other words, an open gap exists between two touching or slightly touching terminals. For example, two touching or two slightly touching conductors can be viewed as an example of an open circuit device in the present invention. A connection between two terminals without open gap is not an open circuit device, for example, a soldering between two conductors can be viewed to have no open gap so that it is not an open circuit device in the present invention.

The first terminal and the second terminal of an open circuit device are not limited in the present invention, for example, they can be conductors or semiconductors.

### Tunnel Diode

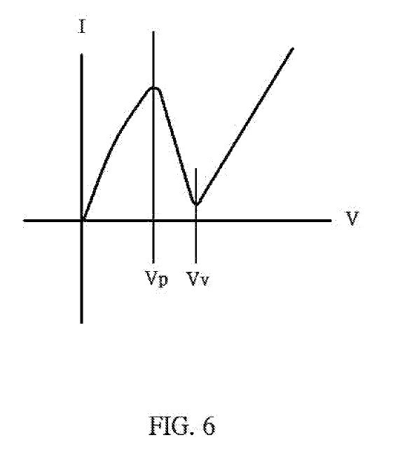

The tunnel diode is known by heavily doping the semiconductor materials used in forming a junction which is called tunnel junction in the present invention. The tunnel diode is a heavily doped junction diode that has a negative resistance at very low voltage in the forward bias direction, due to quantum-mechanical tunneling. The tunnel diode has a region in its voltage current characteristic where the current decreases with increased forward voltage, known as its negative resistance region. FIG. 6 has shown a voltage current characteristic of a typical tunnel diode where the negative resistance region between Vₚ and Vᵥ is shown. FIG. 6 has shown that current starts to decrease at Vₚ where the negative resistance region begins. The Vᵥ where the negative resistance region begins is called “tunnel starting voltage” for tunnel diode in the present invention. The junction of the tunnel diode is called tunnel junction in the present invention.

### LED

LED has a p type region and a n type region separated by a junction or a LED junction. The p type region is dominated by positive electric charges and the n type region is dominated by negative electric charges. When a LED is forward biased (switched on), electrons are able to recombine with electron holes (or holes in short) within the LED, releasing energy in the form of photons. Photon releasing or light emitting is the result of the recombination of electrons and holes in the LED device.

The recombination of electrons and holes excited by a forward bias implies short circuit of which the voltage across the forward biased LED drops and its resistance becomes lowered to present NDR, which can be viewed as a discharge. With the forward bias removed, the voltage across the junction is re-built up and its resistance becomes higher to present PDR, which can be viewed as a charge.

A forward voltage exciting a LED to start an initial light-emitting is called light-emitting starting voltage. A chosen sufficient forward voltage to optimally drive a LED to emit light is called working voltage of the LED in the present invention.

For example, if a forward bias equal to the working voltage is applied to a LED at a frequency and each forward bias is applied at a time when the active region of the LED is recovered to a significant level after its previous recombination, then the LED will be characterized more like as a capacitive loading and has time to rest by this periodical charges and discharges. If a LED is operated more like a capacitive loading, then the LED will more efficiently transform the electricity into an optical energy with more virtual power and less real power, more particularly, it will consume less power, emit brighter light and produce less heat.

The bandwidth of LED is very high up to x-band or higher depending on its emitting colors so that it is very hard to find a power source to come up with this high frequency. The problem can be solved by the present invention. A LED is known as laser diode if light emitted by the LED is a coherent light characterizing very narrow bandwidth. The term “LED” used in the present invention includes laser diode.

### The Budden Tunneling Factor

K. G. Budden considered the wave equation in the form (1)

$$\frac{{d}^{2} E}{d {x}^{2}} + ( \frac{β}{x} + \frac{{β}^{2}}{{η}^{2}} ) E = 0 \qquad ( 1 )$$

where E stands for an energy wave and x stands for the wave travelling distance of the energy wave E. If the value x is very small, then the term

$$\frac{β}{x}$$

dominates the wave equation. Budden concluded that when the number of wavelengths (travelling distance) is small, appreciable tunneling occurs through the evanescent region and when the value of x is too large, no tunneling occurs. For the purpose of convenience, the number of wavelengths for the appreciable tunneling governed by the wave equation above is called “Budden distance” in the present invention.

### Circuit

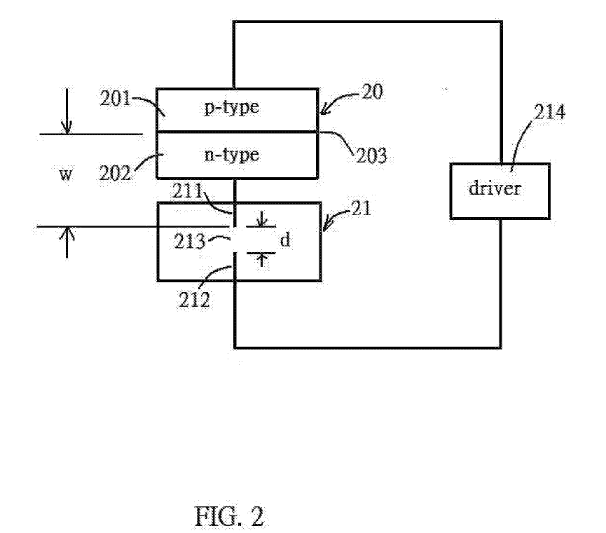

FIG. 2 has shown a first circuit which comprises a LED 20, an open circuit device 21 and a driver 214 electrically connected in series with each other. The LED 20 and the open circuit device 21 are driven by the driver 214. The LED 20 is simply expressed by a p-type device 201, a n-type device 202 and a pn junction 203 or a LED junction 203 formed by the contact of the p-type device 201 and the n-type device 202. The open circuit device 21 comprises a first terminal 211 and a second terminal 212 separating the first terminal 211 by an open gap 213 having an open gap width d. A distance w shown in FIG. 2 is between the open gap 213 of the open circuit device 21 and the LED junction 203. The distance w is a characteristic length which can be measured between the first terminal 211 of the open circuit device 21 and the LED junction 203 as shown in FIG. 2.

Assuming the shapes of the first terminal 211 and the second terminal 212 are point (or needles), in other words, a point-to-point electrical discharge between the first terminal 211 and the second terminal 212 of the open circuit device 21. For the purpose of convenience, assuming the open gap width d of the open gap 213 formed by the first terminal 211 and the second terminal 212 of the open circuit device is fixed.

The driver 214 having a specific baseband provides a forward bias no higher than a chosen working voltage of the LED 20 across the LED 20 and the open circuit device 21. The driver 214 periodically not continuously provides power to the LED 20 so that the LED 20 has time to rest and consumes less power as expected.

The carrier of the open circuit device 21 should be carried on the forward bias between the light-emitting starting voltage, which is a voltage to initially turn on the LED 20 to emit light, and the working voltage, which is a voltage to optimally drive the LED to emit light, so that the discharge starting voltage of the open circuit device 21 should be lower than or equal to (or no higher than) the light-emitting starting voltage of the LED 20 to make sure the electrical discharges of the open circuit device 21 take place at the forward bias between the light-emitting starting voltage and the working voltage of the LED 20. LED is a current driven device so that significant current can be observed between the light-emitting starting voltage and the working voltage of the LED 20.

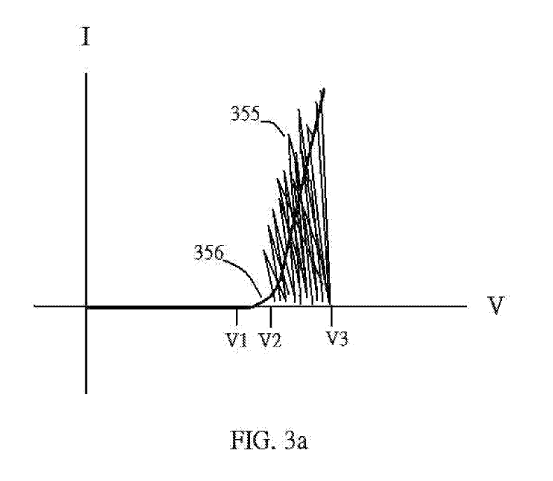

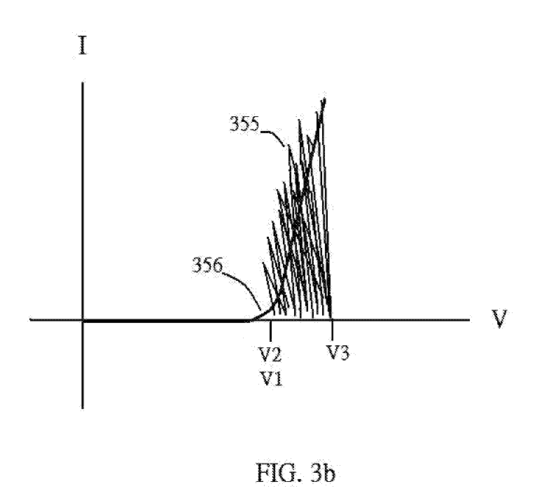

FIG. 3a has shown the I-V curve seen at the open circuit device 21 of the first circuit of FIG. 2. A V₁, V₂ and V₃ shown in FIG. 3a and FIG. 3b are respectively the discharge starting voltage of the open circuit device 21, the light-emitting starting voltage of the LED 20 and the working voltage of the LED 20. FIG. 3a has shown V₁ is lower than V₂ and FIG. 3b has shown V₁ is equal to V₂. FIG. 3a has shown the driver 214 provides a voltage to first reach the discharge starting voltage of the open circuit device 21 to start an initial electrical discharge and the voltage provided by the driver 214 will keep going up to the light-emitting starting voltage of the LED 20 to turn on the LED 20 to emit light and then the voltage from the baseband will keep going up until the working voltage of the LED 20 is reached.

FIG. 3a has shown the frequency response 365 of the open circuit device 21 is carried on the forward bias between the light-emitting starting voltage V₂ and the working voltage V₃ of the LED 20. The modulation between the light-emitting starting voltage and the working voltage of the LED 20 presents very high frequency currents between zero and a value characterized by the open circuit device as earlier revealed.

If the distance w between the open gap 213 of the open circuit device 21 and the LED junction 203 shown in FIG. 2 is large enough, then the high-frequency carrier 355 of the modulation between the light-emitting starting voltage and the working voltage seen in FIG. 3a will very possibly be dissipated in the other energy form such as heat or radiation before being significantly delivered to the LED junction 203 so that the distance w between the open gap 213 of the open circuit device 21 and the LED junction 203 is critical.

A modulated power waveform is obtained by the modulation of the waveform of the open circuit device 21 and the waveform of the driver 214, and a bandwidth of the modulated power waveform is the multiplication of the bandwidth of the open circuit device 21 and the bandwidth of the driver 214, and the bandwidth of the modulated power waveform should be high enough to cover the bandwidth of the LED 20 for increasing matching chances between the bandwidth of the modulated power waveform and the bandwidth of the LED 20.

To improve the matching between the modulated power waveform and the impedance of the LED 20 are (1) the distance between the open gap of the open circuit device and the LED junction is within a Budden distance associated with the modulated power waveform so that appreciable tunneling occurs at the LED junction and (2) the bandwidth of the modulated power waveform should be high enough to cover the bandwidth of the LED 20 for increasing the matching chances between them. If the matching between the modulated power waveform and the waveform of the LED 20 is improved, then the LED 20 will benefit lower junction temperature and emit brighter light in a more capacitive way.

The high-frequency modulated power waveform can be viewed as propagating energy wave. The modulated power waveform can be viewed as E in the wave equation and the energy of the modulated power waveform should be delivered to and responded by the LED junction 203 so that the distance between the open gap 213 of the open circuit device 21 and the LED junction 203 is critical as indicated earlier. The distance w between the open gap 213 of the open circuit device 21 and the LED junction 203 shown in FIG. 2 should be within a Budden distance associated with the modulated power waveform so that the appreciable tunneling excited by the modulated power waveform takes place at the LED junction 203. The open circuit device 21 functions as a modulator coupling in very close distance with the main loading LED 20 to deliver high frequency current tunneling into the LED junction 203.

The tunneling taking place in the LED junction 203 by the modulated power waveform contains very high-frequency currents which swing between zero and a non-zero value. Zero current is the result of no electrical discharge between the two terminals 201, 202 of the open circuit device 21 and stands for no recombination of electrons and holes to emit no light for the LED to rest. Current with the non-zero value stands for a significant recombination of electrons and holes to emit light. Obviously, the light-emitting of the LED is dominated by the tunneling excited by the modulated power waveform which capacitively drives the LED having advantages as revealed earlier.

The smaller distance w is, the larger tunneling takes place in LED junction 203, in other words, the modulated power waveform delivers the most power within its first wavelength propagation or 0≦w≦1 wavelength of the modulated power waveform or 0≦w≦1 wavelength of the LED junction 203. w=0 means that the open gap 213 of the open circuit device 21 is right located at the LED junction 203.

The bandwidth of the modulated power waveform is designed to match the known bandwidth of the LED, in other words, the bandwidth of the modulated power waveform is decided by the bandwidth of the LED 20 and the bandwidth of the LED 20 is known so that the wavelength of the modulated power waveform can also be expressed in term of the wavelength of the LED 20 and the Budden distance associated with the modulated power waveform can be expressed in term of the known frequency response of the LED junction because frequency is inversely proportional to wavelength.

A thermal generated in the LED junction 203 of the LED 20 can be propagated to the nearby open circuit device 21 to further increase the uncertainty to its electrical discharge, for example, the geometric shapes and the material properties of the first and second terminals 211, 212 of the open circuit device 21 might be varied to the thermal causing the behavior of the electrical discharge of the open circuit device to be more unpredictable. For example, its frequency responses, the discharging routes between its two terminals 211, 212 and discharge voltage randomly vary in a more unpredictable way resulting in a more complicated resistance patterns between the first terminal 211 and the second terminal 212 of the open circuit device 21.

The tunneling excited by the modulated power waveform contains a lot different high-frequency currents to excite different points in the LED junction 203 to emit lights and the frequency responses of two or more light-emitting points in the LED junction 203 can correlate with each other to produce more frequency responses or optical resonances resulting in emitting brighter, richer and broader bandwidth color in a more capacitive way. The bandwidth of the driver 214 is adjustable for dimming light up or down.

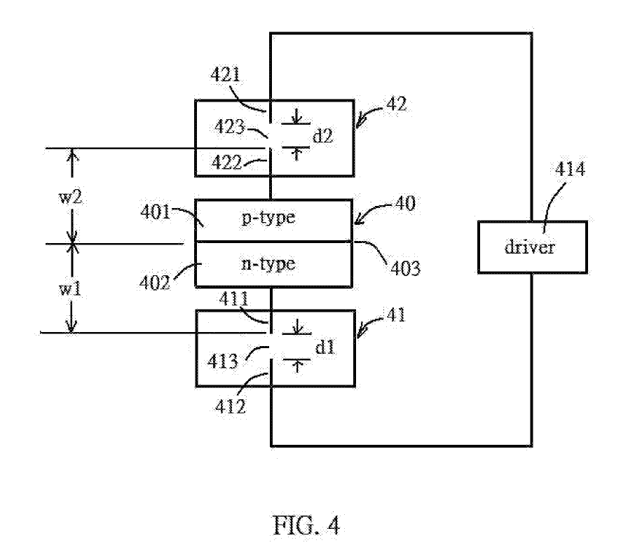

LED has two sides by each of which can be disposed an open circuit device. FIG. 4 has shown a second circuit that comprises a first open circuit device 41, a second open circuit device 42 and a driver 414 and a LED 40 electrically connected in series with each other of which the LED 40 sits between the first open circuit device 41 and the second open circuit device 42. The first open circuit device 41 has a first open gap 413 with a first open gap width d₁ and the second open circuit 42 has a second open gap 423 with a second open gap d₂. The LED 40 has a LED junction 403.

A modulated power waveform is formed by the modulation of the waveform of the first open circuit device 41, the waveform of the second open circuit devices 42 and the waveform of the driver 414 and a bandwidth of the modulated power waveform is the multiplication of the bandwidths respectively of the two open circuits 41, 42 and the bandwidth of the driver 414 so that the bandwidth of the modulated power waveform can be a lot higher than that of the first circuit with single open circuit device.

FIG. 4 has shown that a first distance w₁ is the distance between the first open gap 413 and the LED junction 403 and a second distance w₂ is the distance between the second open gap 423 and the LED junction 403. Each of the w₁ and w₂ should be within a Budden distance associated the modulated power waveform so that the appreciable tunnelings excited by the modulated power waveform takes place at the LED junction 403.

The modulated power waveform delivers the most power within its first wavelength propagation or 0≦w₁, w₂≦1 wavelength of the modulated power waveform or 0≦w₁, w₂≦1 wavelength of the LED junction 403. w₁=0 means that the first open gap 413 of the first open circuit device 41 is right located at the LED junction 403. w₂=0 means that the second open gap 423 of the second open circuit device 42 is right located at the LED junction 403. The bandwidth of the driver 414 is adjustable for dimming light up or down.

The open circuit in the first circuit and the second circuit respectively of FIG. 2 and FIG. 4 has also advantaged that once electrons jumping from a first side to a second side over its open gap the electrons carrying the frequency response of the loading (the LED junction) will not reversely jump back from the second side to the first side over its open gap to the driver, which eliminates the noise from the high-frequency loading (the LED junction 203) to cause interference to the power source (the driver 214).

As revealed earlier, the shapes of the first terminal and the second terminal of the open circuit can be surfaces which can be viewed as constructed by a plurality of points or a micro-needle array, in other words, a surface-to-surface discharge can be viewed as micro-needle-array-to-micro-needle-array discharges. A surface-to-surface discharge or a micro-needle-array-to-micro-needle-array discharges allows bigger current discharge (bigger power discharge).

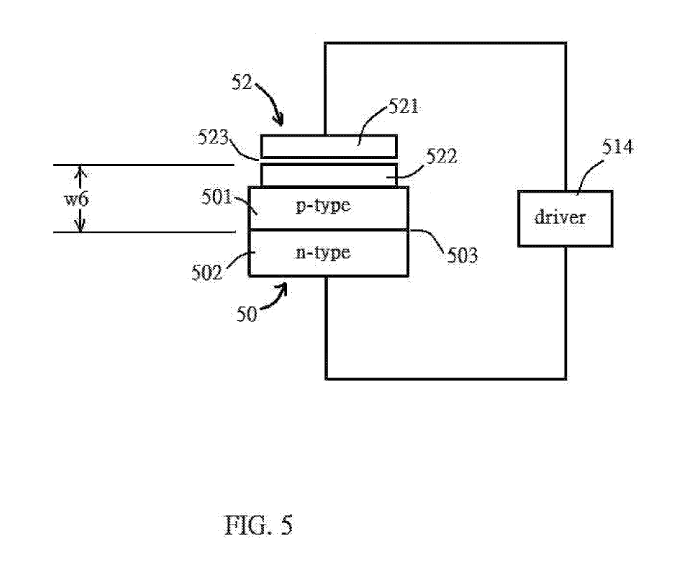

FIG. 5 has shown both a first terminal 521 and a second terminal 522 of an open circuit device 52 in surface shape and an open gap 523 between the first terminal 521 and the second terminal 522 of the open circuit device 52 is seen. A w₆ is the distance between the open gap 523 of the open circuit device 52 and a LED junction 503.

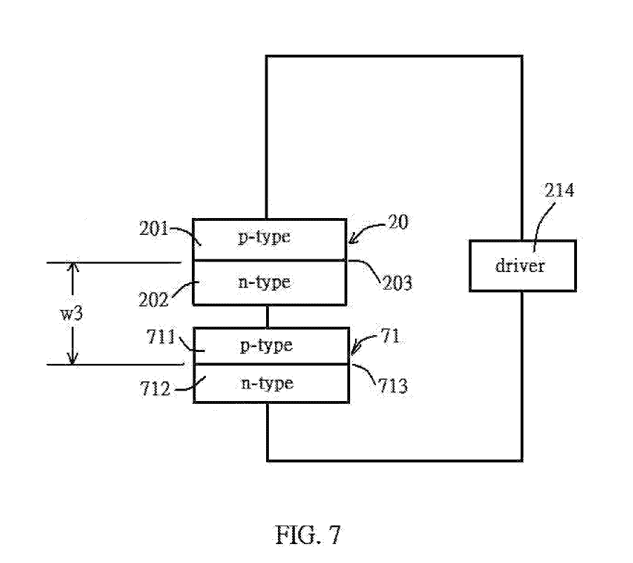

Each of the open circuit device 21 shown in FIG. 2 and FIG. 4 can be respectively substituted by a tunnel diode. The open circuit device 21 of FIG. 2 is substituted by a tunnel diode 71, which is shown in FIG. 7. The tunnel diode 71 has a tunnel junction 713 and a distance w₃ is between the tunnel junction 713 and the LED junction 203 and the w₃ is smaller than its the Budden distance associated with its modulated power waveform.

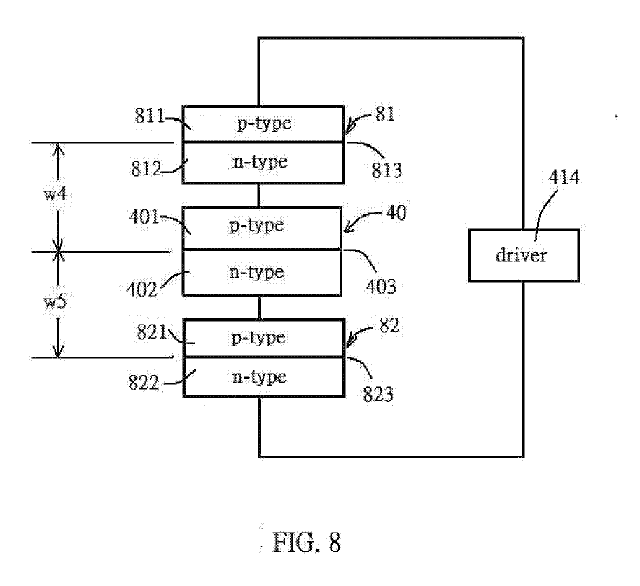

The first open circuit device 41 and the second open circuit device 42 of FIG. 4 are respectively substituted by a first tunnel diode 81 and a second tunnel diode 82, which is shown in FIG. 8. The first tunnel diode 81 has a first tunnel junction 813 and the second tunnel diode 82 has a second tunnel junction 823.

A distance w₄ is between the first tunnel junction 813 and the LED junction 403 and a distance w₅ is between the second tunnel junction 823 and the LED junction 403. The w₄ and w₅ are smaller than a Budden distance associated with its modulated power waveform.

In nowadays technology, the bandwidth of the tunnel diode is narrow compared to that of the open circuit device and the tunnel starting voltage of the tunnel diode is not as low as that of the open circuit device. The LED in the invention is not limited and the color emitted by the LED is not limited, for example, the “LED” used in the present invention includes laser diode. The present invention has characterized to improve the efficiency of LED without needing to change the illuminating structure of the LED.

What is claimed is:

1. A modulated LED, comprising:
a LED having a LED junction; and
an open circuit device having a first terminal and a second terminal separating the first terminal by an open gap,
wherein the LED and the open circuit device are electrically connected in series, and a distance between the LED junction of the LED and the open gap of the open circuit device is within a Budden distance associated with a modulated power waveform obtained by the modulation of an input electrical power applied across the LED and the open circuit device and a frequency response of the open circuit device driven by the input electrical power to make sure an appreciable tunneling excited by the modulated power waveform takes place at the LED junction.

2. The modulated LED of claim 1, wherein the LED has a light-emitting starting voltage and has a chosen working voltage, and the open circuit device has a discharge starting voltage, and the input electrical power has a bandwidth and provides a voltage equal to the chosen working voltage of the LED across the LED and the open circuit device, and the discharge starting voltage of the open circuit device is no higher than the light-emitting starting voltage of the LED to make sure an initial electrical discharge of the open circuit device takes place before or at a same time the LED initially emits light resulting in making sure electrical discharges take place between the light-emitting starting voltage and the chosen working voltage of the LED, and a bandwidth of the modulated power waveform is higher than a bandwidth of the LED to make sure that the bandwidth of the modulated power waveform covers the bandwidth of the LED.

3. The modulated LED of claim 2, wherein the bandwidth of the input electrical power applied across the open circuit device and the LED is adjustable for dimming light down or up.

4. The modulated LED of claim 3, further comprising a third terminal neighboring the first terminal and the second terminal of the open gap of the open circuit device, wherein an application of an electrical field on the third terminal varies an impedance between the first terminal and the second terminal of the open circuit device to adjust an emitting color of the LED.

5. The modulated LED of claim 1, wherein the distance between the open gap of the open circuit device and the LED junction is smaller than 1 wavelength of the modulated power waveform.

6. The modulated LED of claim 5, wherein the LED has a light-emitting starting voltage and has a chosen working voltage, and the open circuit device has a discharge starting voltage, and the input electrical power has a bandwidth and provides a voltage equal to the chosen working voltage of the LED across the LED and the open circuit device, and the discharge starting voltage of the open circuit device is no higher than the light-emitting starting voltage of the LED to make sure an initial electrical discharge of the open circuit device takes place before or at a same time the LED initially emits light resulting in making sure electrical discharges take place between the light-emitting starting voltage and the chosen working voltage of the LED, and a bandwidth of the modulated power waveform is higher than a bandwidth of the LED to make sure that the bandwidth of the modulated power waveform covers the bandwidth of the LED.

7. The modulated LED of claim 4, wherein the open gap of the open circuit device is filled with a gas to isolate the first terminal and the second terminal of the open circuit device from outside environment against oxidizing or an ion-release device is disposed at the open gap of the open circuit device under an influence of an electrical field to release ions that change the conductivity between the first terminal and the second terminal of the open circuit device resulting in affecting the electrical discharge.

8. The modulated LED of claim 5, wherein the open gap of the open circuit device is filled with a gas to isolate the first terminal and the second terminal of the open circuit device from outside environment against oxidizing or an ion-release device is disposed at the open gap of the open circuit device under an influence of an electrical field to release ions that change the conductivity between the first terminal and the second terminal of the open circuit device resulting in affecting the electrical discharge.

9. A modulated LED, comprising:
a LED having a LED junction;
a first open circuit device having a first terminal and a second terminal separating the first terminal by a first open gap; and
a second open circuit device having a first terminal and a second terminal separating the first terminal by a second open gap;
wherein the first open circuit device, the LED and the second open circuit device are electrically connected in series with each other with the LED disposed between the first open circuit device and the second open circuit device, and a first distance between the LED junction of the LED and the first open gap of the first open circuit device and a second distance between the LED junction of the LED and the second open gap of the second open circuit device are respectively within a Budden distance associated with a modulated power waveform obtained by a modulation of an input electrical power applied across the first open circuit device and the second open circuit device, a frequency response of the first open circuit device driven by the input electrical power and a frequency response of the second open circuit device driven by the input electrical power to make sure appreciable tunnelings excited by the modulated power waveform take place at the LED junction.

10. The modulated LED of claim 9, wherein the LED has a light-emitting starting voltage and has a chosen working voltage, and the first open circuit device has a first discharge starting voltage, and the second open circuit device has a second discharge starting voltage, and the input electrical power has a bandwidth and provides a voltage equal to the chosen working voltage of the LED across the first open circuit device and the second open circuit device, and the first discharge starting voltage of the first open circuit device and the second discharge starting voltage of the second open circuit device are respectively no higher than the light-emitting starting voltage of the LED to make sure an initial electrical discharge of the first open circuit device and an initial electrical discharge of the second circuit device before or at a same time the LED initially emits light resulting in making sure the electrical discharges respectively of the first open circuit device and the second open circuit device take place between the light-emitting starting voltage and the chosen working voltage of the LED, and a bandwidth of the modulated power waveform is higher than a bandwidth of the LED to make sure that the bandwidth of the modulated power waveform covers the bandwidth of the LED.

11. The modulated LED of claim 10, wherein the bandwidth of the input electrical power applied across the first open circuit device and the second open circuit device is adjustable for dimming light down or up.

12. The modulated LED of claim 11, further comprising a third terminal neighboring the first terminal and the second terminal of any one of the first open gap and the second open gap respectively of the first open circuit device and the second open circuit device, wherein an application of an electrical field on the third terminal varies an impedance between the first terminal and the second terminal to adjust the emitting color of the LED.

13. The modulated LED of claim 9, wherein the first distance between the first open gap of the first open circuit device and the LED junction and the second distance between the second open gap of the second open circuit device and the LED junction are respectively smaller than 1 wavelength of the modulated power waveform.

14. The modulated LED of claim 13, wherein the LED has a light-emitting starting voltage and has a chosen working voltage, and the first open circuit device has a first discharge starting voltage, and the second open circuit device has a second discharge starting voltage, and the input electrical power has a bandwidth and provides a voltage equal to the chosen working voltage of the LED across the first open circuit device and the second open circuit device, and the first discharge starting voltage of the first open circuit device and the second discharge starting voltage of the second open circuit device are respectively no higher than the light-emitting starting voltage of the LED to make sure an initial electrical discharge of the first open circuit device and an initial electrical discharge of the second circuit device before or at a same time the LED initially emits light resulting in making sure the electrical discharges respectively of the first open circuit device and the second open circuit device take place between the light-emitting starting voltage and the chosen working voltage of the LED, and a bandwidth of the modulated power waveform is higher than a bandwidth of the LED to make sure that the bandwidth of the modulated power waveform covers the bandwidth of the LED.

15. The modulated LED of claim 14, wherein the first open circuit device and the second open circuit device are respectively filled with a gas to isolate their associated the first terminal and the second terminal from outside environment against oxidizing or an ion-release device is disposed at the first open gap of the first open circuit device and the second open gap of the second open circuit device under the influence of the electrical field to release ions that change the conductivity between their associated the first terminal and the second terminal.

16. The modulated LED of claim 10, wherein the first open circuit device and the second open circuit device are respectively filled with a gas to isolate their associated the first terminal and the second terminal from outside environment against oxidizing or an ion-release device is disposed at the first open gap of the first open circuit device and the second open gap of the second open circuit device under the influence of the electrical field to release ions that change the conductivity between their associated the first terminal and the second terminal.

17. A modulated LED, comprising:
a LED having a LED junction; and
a first open circuit device having a first terminal and a second terminal separating the first terminal by a first open gap,
wherein the LED and the first open circuit device are electrically connected in series, and a first distance between the LED junction of the LED and the first open gap of the first open circuit device is within a Budden distance associated with a frequency response of the LED junction of the LED.

18. The modulated LED of claim 17, further comprising a second open circuit device having a first terminal and a second terminal separating the first terminal by a second open gap, wherein the first open circuit device, the LED and the second open circuit device are electrically connected in series with each other with the LED disposed between the first open circuit device and the second open circuit device, and the second distance between the LED junction of the LED and the second open gap of the second open circuit device is within the Budden distance associated with the frequency response of the LED junction of the LED.

19. The modulated LED of claim 17, wherein the first distance between the LED junction of the LED and the first open gap of the first open circuit device is within 1 wavelength associated with the frequency response of the LED junction of the LED.

20. The modulated LED of claim 18, wherein the first distance between the LED junction of the LED and the first open gap of the first open circuit device is within 1 wavelength of the frequency response of the LED junction of the LED, and the second distance between the LED junction of the LED and the second open gap of the second open circuit device is within 1 wavelength associated with the frequency response of the LED junction of the LED.

21. The modulated LED of claim 17, further comprising a third terminal neighboring the first terminal and the second terminal of the first open gap of the first open circuit device, wherein an application of an electrical field on the third terminal varies an impedance between the first terminal and the second terminal of the first open circuit device to adjust an emitting color of the LED.

22. The modulated LED of claim 18, further comprising a third terminal neighboring the first terminal and the second terminal of any one of the first open gap and the second open gap respectively of the first open circuit device and the second open circuit device, wherein an application of an electrical field on the third terminal varies an impedance between the first terminal and the second terminal to adjust an emitting color of the LED.
